(19) United States
(12) Patent Application Publication
(10) Pub. No.: US 2004/0065731 A1
(43) Pub. Date: Apr. 8, 2004

(54) Automated television/telephone rental system

(76) Inventor: Friedrich Vesterling, Blasdell, NY (US)

Correspondence Address: David L. Principe, Hodgson Russ LLP, Suite 2000, One M&T Plaza, Buffalo, NY, 14203-2391, US

(21) Appl. No.: 10/452,108

(22) Filed: Jun. 2, 2003

Related U.S. Application Data
(60) Provisional application No. 60/384,598, filed on May 31, 2002.
(60) Provisional application No. 60/385,760, filed on Jun. 4, 2002.

(51) Int. Cl. G06K 5/00

(52) U.S. Cl. 235/382

(57) ABSTRACT

An automated rental apparatus comprising a smart card control module and a television control module or telephone control module. The smart card control module includes a card reader. A smart card containing data regarding available funds and other parameters is used with the SCCM to determine the output to a command generator for a television or a touch tone generator for a telephone switch.

### CROSS-REFERENCE TO RELATED APPLICATION

This application claims the benefit of U.S. Provisional Application No. 60/384,598 filed May 31, 2002, entitled “Automated Television/Telephone Rental System” which is incorporated herein by reference, and claims the benefit of U.S. Provisional Application No. 60/385,760 filed Jun. 4, 2002, entitled “Extended Area Code and Long Distance Rental System” which is hereby incorporated by reference.

### FIELD OF INVENTION

The present invention pertains to automated control systems for television and telephone rental.

### BACKGROUND OF THE INVENTION

In hotels and hospitals there is a need for automated equipment for rental of telephones and televisions. With regard to televisions in hospitals in the United States, there are normally at least three channel groups, namely, free channels which may include a hospital information channel and patient education channels, commercial channels, and secure staff and education channels not suitable for general viewing. With regard to telephones, there are different levels including in-house calls, long distance calls, regional calls and local area calls.

The television controls in hospitals typically comprise hard-wired units that draw their operating power from the television or nurse call system. A typical TV pillow speaker/control unit has the control buttons wired to the television set via a cable exiting from the bottom of the unit. The wires include a system ground wire, an audio to speaker wire, and a channel up wire. Pushing the channel up button past the highest channel will turn the TV off.

With the increase in the number of channels that are available, the simple channel up switch closure described above is no longer suitable. Too many channels have to be passed over to reach the power off. Accordingly, there have been developments whereby intelligent hand units and intelligent control decoders in television sets have been able to communicate through encoded pulse trains transmitted over the control wires. In the old technology a simple switch closure was interpreted as a channel up signal. In the newer technology, an encoded pulse train is sent to the television. The television decodes the pulse train and acts on the channel up, channel down, volume up/down and on/off control signals. In addition to these controls for use by patients, other codes are available for control of the channel groups described above.

In some hospital settings the bedside television is suspended on a spring loaded arm within the reach of the patient. With this type of television, the only thing that the patient manipulates is the buttons. There is no pillow speaker and no infrared remote control unit is used. The buttons used may be on the television or on the smart card control module externally mounted on the television. If there is sufficient room, the smart card control module may be mounted inside the television such that the original television control buttons may be utilized. If the original buttons are used, the television wiring has to be modified by routing the buttons to the smart card control module. The button pushes are routed through the smart card/key control (SCCM) and television rental module (TVRM) which sends the commands to the television as described herein.

In a manual television rental system a host/hostess will provide access to the commercial channels for renting by means of a master remote control. To disable the rental channels, the host/hostess selects the free channels with the master remote. The master remote control is available on a limited basis from the television manufacturer or distributor only. The master control type system can also be accomplished through a hard-wired system.

The miniaturization of computer chips has led to the development of “smart” cards having onboard microprocessors with processing capabilities and memory for storage. The cards have evolved from the read only magnetic strips to powerful onboard microprocessors.

What is needed is a system that combines the smart card technology with the technology for automated control of televisions and other devices for rental purposes.

### SUMMARY OF THE INVENTION

The present invention meets the above-described need by providing an automated rental system for control of rental televisions and telephones.

In a preferred embodiment, an automated television rental system suitable for the hard-wired television control units is provided. A smart card control module (22) is connected either in parallel or series with the pillow/speaker control unit. These parallel elements are connected to the control wire carrying pulse train instructions to the television set. In the case of a series connection, the smart card control module is interposed between pillow/speaker control unit and the TV. The smart card control module is capable of emitting pulse trains via the television rental module (TVRM) that can instruct the television to open a specific channel group for viewing (with pulse trains just as a host/hostess master remote control or intelligent pillow speaker can generate). Furthermore in the case of series connectivity, the smart card control module can convert switch closures from the pillow/speaker control units to an intelligent pulse train understood by the TV, such as channel up or channel down or off. This is particularly useful if a large number of channels are available for viewing by the patient and the patient wishes to view another channel that requires a large number of button pushes. The smart card control module can sense the repeated pushes or long continuous push and instruct the TV to step perhaps 5 channels at once instead of individually. Furthermore, a long continuous button push may instruct the TV to shut off, avoiding a large number of channel changes to reach the “off” position (usually after the highest channel number).

As an alternative to control through “tiers” of available channels, the smart card control module may be provided with a look-up table with available “free” and “pay” channels. Based on the look-up table, the smart card control module generates commands via a command generator for controlling the television.

While the smart card is inserted in the pillow/speaker control hand unit, a rental charge is deducted from the balance of funds or balance of rental time registered on the card. The deduction occurs on a time basis according to an internal clock on the smart card control module. Referencing the time period to a clock external to the smart clock module is also included in the present invention. If the balance reaches zero, the smart card control module will send a pulse train via the TVRM to the television that will cause the television to return to the free channel group. If there is still a balance on the card, the smart card control module will continue to send a signal to use the commercial channel group or enhanced commercial group. This signal is sent to assure a rental state. This method relies partly on using the three or four channel tiering capability of the hospital TV set and switching between tiers to control rental.

Another method of controlling channel access for rental is to have groups of viewable channels programmed into the smart card control module. A free group of channels is accessed when the card balance reaches “0,” and a “free” plus “rental group” of channels is accessed when the balance is not “0.” The channels of the “rental group” can be manipulated at time of card purchase or modified by commands sent to the smart card control module (hardwire, infra-red (IR) or radio frequency or audio frequency(i.e., touch-tones). Different “rental groups” allows the choice between BASIC and PREMIUM rental. The “free channel” group may also be manipulated to avoid the possibility of, for example, a hospital in-house patient education channel presenting material on breast feeding to be viewed by a patient in a surgical unit. Each SCCM is assigned a “fixed” address. The physical location of each SCCM can therefore be associated with a specific bed location and more broadly the type of patient ward in which it is located. This “location” information is used to modify the “pay” and “free” lookup lists to achieve secure patient education channels. It can be made specific to the point where only one specific “address” or bed or staff education site is allowed access to a specific channel.

A signal is also sent to the television when the card is first inserted. If there is a sufficient balance, the signal will correspond to the commercial channel group, or enhanced commercial channel group (additional cable or satellite channels beyond the basic commercial channels). If there is a zero balance, the signal will correspond to the free channel group. If no card is detected, the system will send period signals corresponding to the free channel group.

The smart cards will be available for purchase from a cashier or vending machine and are capable of being programmed and re-programmed to bear the correct monetary value.

In the case where a major credit card such as Visa or Mastercard is inserted into the smart card control module, the monetary value of a predetermined amount of rental days will be deducted from the credit card just like any other credit card transaction. The transaction can be held indefinitely in the smart card control module until the module offloads the transaction to a connection via telephone, network, infra-red or other communications means. Alternatively the credit card transaction may be verified immediately through a network or other connection to a company that provides credit card transaction services such as Chase Bank or Payment Tech using real-time credit card verification and billing.

The automated rental system described above is not limited to the hard-wired television/speaker control unit described above. The system is also suitable for infrared remote control systems of the type normally used in hotels. The only difference being that the smart card control module would be integrated into the stand-alone remote control unit and would be capable of transmitting infra-red signals corresponding to the channel groups instead of sending encoded pulse trains over the control wire.

Also, the smart card control circuitry does not have to be integrated into the remote control or TV/pillow speaker unit and may instead be integrated with or tied into the control circuitry for the television unit. Furthermore parallel connectivity is used to simplify wiring changes to the present state of the art system. It is also possible to serially route the previous art “button pushes” or intelligent pulse trains through the smart card control module, the smart card control module merely passing on commands of the prior arts or translating a “button push” to an encoded pulse train. Any number of buttons may be added that can be translated into pulse trains, i.e., volume up, volume down, channel down, on/off, and “yes” and “no” response buttons used in conjunction with “on screen” surveys. The serial mode is also included in the present invention.

Furthermore, the automated rental system described above can also be used to control individual telephone use by means of a smart card control module interfaced with a telephone rental module (PHRM) that is inserted into the telephone line connecting or disconnecting the telephone instrument from the line.

Control is achieved through the smart card control module to indicate whether the telephone should be in the “connected” or “disconnected” state. Furthermore, this module may use intelligence to allow a “connected” state to complete calls to specific phone numbers or phone number prefixes. When a series of digits is dialed that is not in the look-up table, the module immediately goes into the “disconnected” state, and refuses to relay the digits dialed, preventing the call from being completed. The converse is true also in that the module may be configured to refuse call completion to number prefixes in the look-up table.

The look-up table of number, prefixes, or area codes may be sent to the module by a hardwire, infrared, ultrasonic or radio frequency (RF) control signal or read from the smart card directly.

Alternatively the control signal may be sent via the telephone line attached to the module with touch-tones, or the control signal may utilize digital signal carried on the phone line such as DSL.

### BRIEF DESCRIPTION OF THE DRAWINGS

The invention is illustrated in the drawings in which like reference characters designate the same or similar parts throughout the figures of which:

FIG. 1 is a schematic diagram of the control system of the present invention;

FIG. 2 a side view of a TV/pillow speaker unit according to the present invention;

FIG. 3 is a rear view thereof;

FIG. 4 is a block diagram of the television rental system of the present invention;

FIG. 5 is a flow chart of the television rental system of the present invention;

FIG. 6 is a schematic of an alternate embodiment of the control system;

FIG. 7 is another schematic diagram of the embodiment of FIG. 6;

FIG. 8 is a block diagram of the telephone rental system of the present invention;

FIG. 9 is a flow chart of the telephone rental system of the present invention; and,

FIG. 10 is an alternate embodiment of the telephone rental system of the present invention.

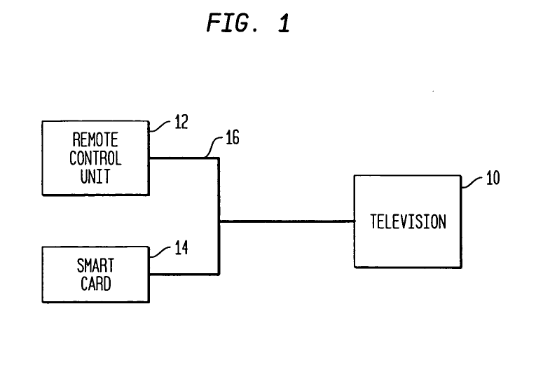

### DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention provides an automated rental system for controlling an electronic device such as a television 10. The television 10 is controlled by a remote control unit 12 that can be either hard-wired or a stand alone battery separated unit. The hard-wired unit derives its operating voltage from the internal power circuit of the television unit. A smart card control module (SCCM) 22 and corresponding circuitry are connected in parallel to the control wire 16. The smart card control module 22 contains a microprocessor that is capable of tracking time, deducting money from a predetermined balance on a time basis, and sending a signal to the television via the television rental module TVRM 50 to select a channel group on the basis of the information regarding the amount of money available on the smart card 14. The preferred embodiment is illustrated in connection with a hard-wired system, however, the smart card control circuitry could also be used in connection with a stand-alone hand held remote or could be completely separate from the hand control unit as will be described herein. For example, the smart card control circuitry could be tied into the television receiver rather than the hand held unit.

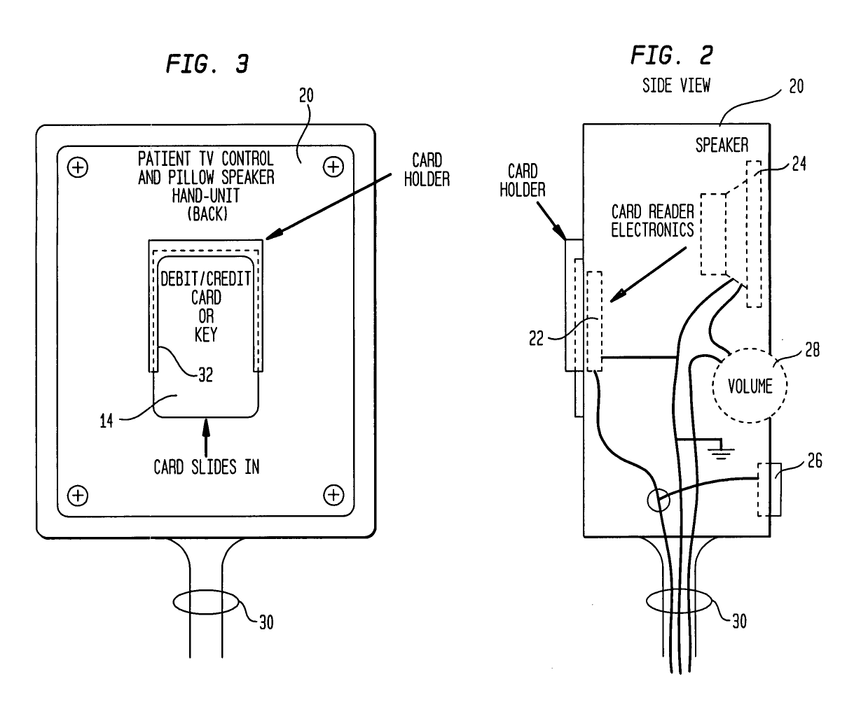

Turning to FIGS. 2 and 3, a specific application of the technology to a hard-wired TV/pillow speaker unit is illustrated. The integrated TV/speaker control and smart card unit includes a hand unit 20 containing the smart card/key control module (SCCM) 22 including a card reader, the speaker 24, a push button control 26, and a volume control 28. The hand unit 20 also includes a television rental module TVRM 50 for generating encoded pulse trains corresponding to the channel selection and on/off control.

The SCCM 22 is connected in parallel with the pillow/speaker control unit. These parallel elements are connected to the control wire 30 carrying pulse train instructions to the television set. The smart card control module 22 causes the TVRM 50 to emit pulse trains that can instruct the television to open a specific channel group for viewing (with pulse trains just as a host/hostess master remote control can generate). While the smart card 14 is inserted in the pillow/speaker control hand unit 20, a rental charge is deducted from the balance of funds registered on the card 14. The deduction occurs on a time basis according to an internal clock on the smart card 14. If the balance reaches zero, the SCCM 22 will send a pulse train via the TVRM to the television that will cause the television to return to the free channel group.

If there is still a balance on the card 14, the SCCM will continue to send a signal to use the commercial channel group. This signal is sent to assure a rental state.

A signal is also sent to the television 10 when the smart card 14 is first inserted into the slot 32 (shown in FIG. 3). If there is a sufficient balance, the signal will correspond to the commercial channel group. If there is a zero balance, the signal will correspond to the free channel group. If no card 14 is detected, the system will send periodic signals corresponding to the free channel group.

The smart cards 14 will be available for purchase from a cashier or vending machine and are capable of being programmed and re-programmed to bear the correct balance of funds.

Smart cards 14 typically include an integrated circuit with a memory element such as random access memory (RAM) and optionally a control unit, such as a microprocessor or microcomputer for secure access. The structure of the integrated circuit is such that it is embedded in a portion of a plastic card having dimensions and physical characteristics of standard credit cards in widespread use. In this application, the terms card and key are used interchangeably because integrated circuits may also come in other forms besides the card described above. A smart key is to be understood to also mean an integrated circuit with a memory element (RAM) and optionally a control unit such as a microprocessor or microcomputer for secure access. The embedded integrated circuit may include a plurality of terminals on an exterior surface of the card to permit internal and external transfer of signals to and from the card. Such a smart card is commonly known as a contact smart card. Other types of smart cards are also included in the present invention. The transfer of signals is accomplished by inserting the card into a compatible reader which provides electrical contacts to interconnect the integrated circuit in the card to a card information processing unit associated with the reader. The reader typically provides power for operating the card, and data is transferred to and from the card whenever it is inserted into the reader. In the present invention the data may include rental value, lookup tables for “free” and “pay” channels, data pertaining to channel “tiers” or the like. Default data related to these parameters may be preloaded into the SCCM as described below.

The above described system uses “tier” control. The television rental module sends a command to the television to use either the “pay” or “free” tier. The module continues to send this command periodically. At this point, the television rental module simply relays channel up/down commands except when the button is pushed repeatedly or held down for a long period of time.

The television rental module may also use a channel “lookup list.” When a channel change “up” is requested the next channel in the “pay” or “free” mode is chosen (usually stored in the SCK) and the “go to” channel XX command is sent to the television. Conversely, a channel “down” command causes the SCCM to look up the previous channel in the list and the command to tune to that channel is sent to the television. The television does not receive channel up or channel down commands, but receives the channel number to tune to. Also, available channels can be added or deleted from a displayed channel list through commands from the television rental module. This method does not require hospital type “tiered” television sets.

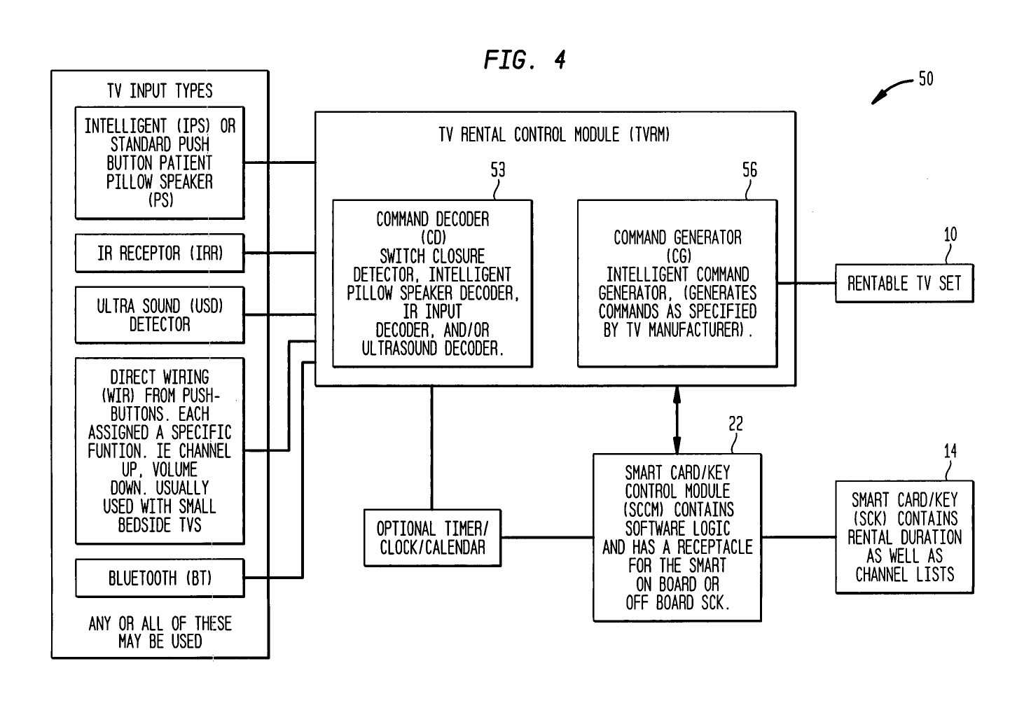

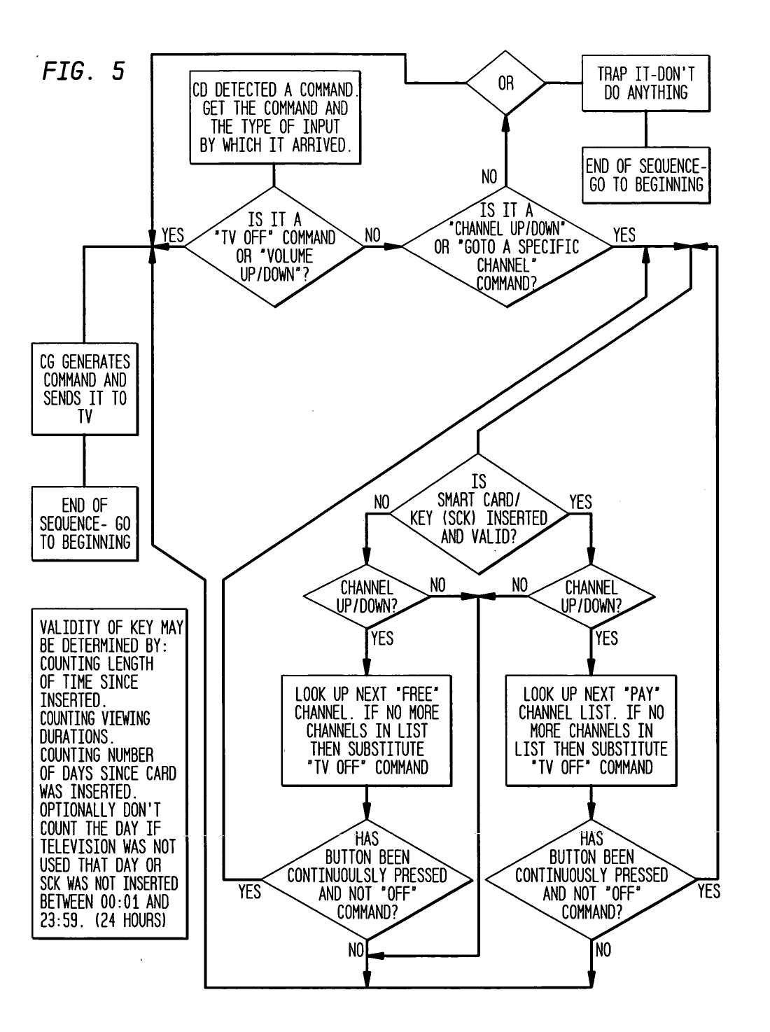

Referring to FIGS. 4 and 5, the television rental control module 50 (TVRM) of the present invention may be used with a variety of input systems. Also, the TVRM 50 may be inserted anywhere between the pillow speaker and the rentable television set. The pillow speaker is the most common form of giving a patient the ability to control a television in a hospital. Television sets for hospital use are equipped with inputs for pillow speakers. With the proliferation of viewable channels, intelligent pillow speakers have been developed in order to facilitate the selection of a particular channel (or on/off) for viewing without having to step through countless channels. Some hospitals and hotels use infrared remotes to control television sets. As another option, an ultrasound device can be used with the system of the present invention. The prior art ultra sound technology in the 1960's by Zenith comprises a remote control containing a “tuning rod” that is struck when the desired command button is pushed. Each command button strikes a different frequency “tuning rod.” In the present invention, a transducer generates the ultra sound frequency and sends a pulse train of ultra sound having a fixed frequency. A different fixed frequency or a different pulse train for each television rental module may be used if more than one television set is used in the same room. The use of different frequencies or frequency shift keying may also be used with the system of the present invention. Ultrasound has some advantages over the other systems. Infrared systems will not operate with bed curtains drawn. The use of intelligent pillow speakers may require cross-room rewiring for control. Also, radio frequency control introduces unwanted RF interference that may affect patient monitoring equipment.

Additional control of the television set may be achieved by holding the channel change button for a specific period of time, after which the continued holding of the button will cause the system to skip three, four, or five channels at a time, each time the television is stepped to another channel. When the top or bottom of the channel list is reached, the television set is turned off.

As shown in FIG. 4, the television rental control module 50 includes a command decoder 53 capable of receiving input from numerous input devices. The television rental control module also includes a command generator 56 capable of generating commands as specified by the manufacturer of the television. The hospital television manufacturers supply “tiers” as a means of control for the availability of pay channels. The television rental module of the present invention is capable of sending “tier” commands to the television to control rental, as well as add or delete channel commands from tiers. Television sets without tiers have the capability of adding and deleting channels displayed when the up/down channel instruction is sent to the television with a remote control.

If a cable box (digital or analog) is used in conjunction with the TV, the channel tuning commands are sent to the cable box.

The smart card key control module SCCM 22 contains software logic and has a receptacle for the smart card/key. Each smart card/key control module 22 (SCCM) contains a unique identifier or address. This address identifies the physical location of the SCCM. When looking up valid “free” and “pay” channels this unique address can be an additional factor in determining what channels are available in each group. For instance in a hospital environment, the obstetrics ward may have educational channels available which display videos on breastfeeding. This channel should never be viewable in a surgery ward, nor should surgical educational channels be available to patients in the obstetrics ward. A smart card/key 14 that contains a code or reference number which is used to fetch rental duration and/or available channels from another source such as a network may be used with the television rental control module. Also, the addition of a keypad (real or virtual) on which the patient can enter a code or reference number may be used with the system of the present invention.

There is a default “free” channel list embedded in the firmware of the SCCM 22. The smart card/key 14 (SCK) may also contain a “free” channel list. If this list exists in the SCK 14, the list is transferred into the SCCM 22 to replace the default “free” channel list. This list is used when the SCK 14 “pay” mode expires. This method may be used to keep the “free” channel list updated.

The SCCM 22 is capable of reading magnetic stripe cards/keys, intelligent microprocessor controlled cards/keys (T0, T1 or I²/C are preferred because they cannot be easily duplicated) as well as memory card/keys. In addition, the SCCM 22 is capable of reading stick memory.

The SCCM 22 can also read major magnetic stripe credit cards. Payment for rental can be processed by the patient inserting their credit card into the SCCM 22. The SCCM 22 uses an optional modem to contact the clearing house acting as a credit card terminal, or sends the information to the credit processing server, which completes the transaction. The allotted or additional rental can then be transferred to the SCK 14.

The SCK 14 may be purchased through the gift shop, cafeteria, restaurant front desk or cashier. Refunds are given by reading the card to determine the rental value remaining on the card. The renting entity or hospital is assured of receiving the proper revenue because the amount of the monies is determined when the SCK 14 is encoded with the duration of the rental. Cards may be encoded for any duration of rental and priced according to rental duration. To facilitate the dispensing and refund scenarios, a kiosk may be employed that will dispense the SCK 14. A user may input cash or insert a credit card. The desired amount of rental is then encoded to the SCK 14 and the SCK 14 is vended. To obtain a refund, the SCK 14 is inserted into the kiosk and the refund is by cash dispensed by the kiosk, or by crediting the credit card. Additional rental duration may be added to the SCK 14 at any time using the kiosk.

Turning to FIG. 5, in the “lookup table” method of control, the system operation commences when the command decoder 53 detects a command. The system retrieves the command and the type of input by which it arrived. The system detects whether it is a “TV off” command or a “volume up/down” command. If it is one of these types of commands, then the command generator 56 generates the corresponding command and sends it to the television set. If the command is not a TV off or volume command, then the system detects whether it is a “channel up/down” or “go to a specific channel command.” If so, the system checks whether a smart card/key 14 is inserted and valid. The validity of the smart card/key 14 may be determined by counting the length of time since the card/key was inserted; counting viewing durations; counting the number of days since the card was inserted. As an option the system can be set to not count the day if the television was not used that day.

If the smart card has not been inserted or is not valid, the system checks whether the channel up/down signal has been sent. If so, the system looks up the next “free” channel. If there are no more channels in the list then the “TV off” command is substituted. If the signal is not a channel up/down signal, then the command generator 56 generates the corresponding signal and sends it to the television set 10.

If the system detects a smart card/key 14 that is valid and a channel up/down signal then the system looks up the next “pay” channel in the list. If there are no more pay channels in the list then the “TV off” command is substituted.

The logic described above in connection with FIG. 5, is used if the television rental module is connected in serial mode. The system may also be connected in parallel mode. If connected in parallel, rental control can still be achieved by utilizing “tier” control as described previously. An alternate method is to monitor the channel command sent to the television and if it is not a channel associated with the “pay” or “free” list, the television rental module sends an additional channel command that tunes the television to a channel appearing in the look-up list.

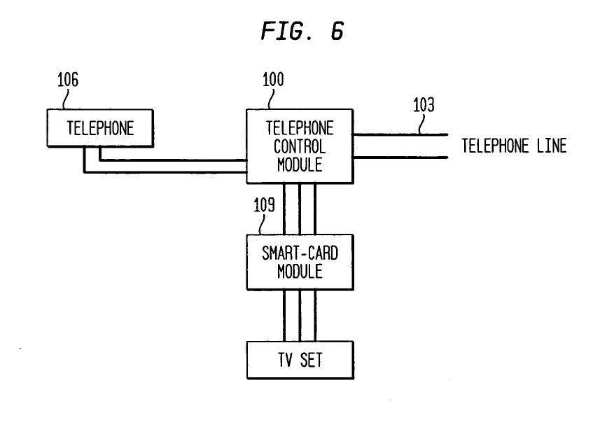

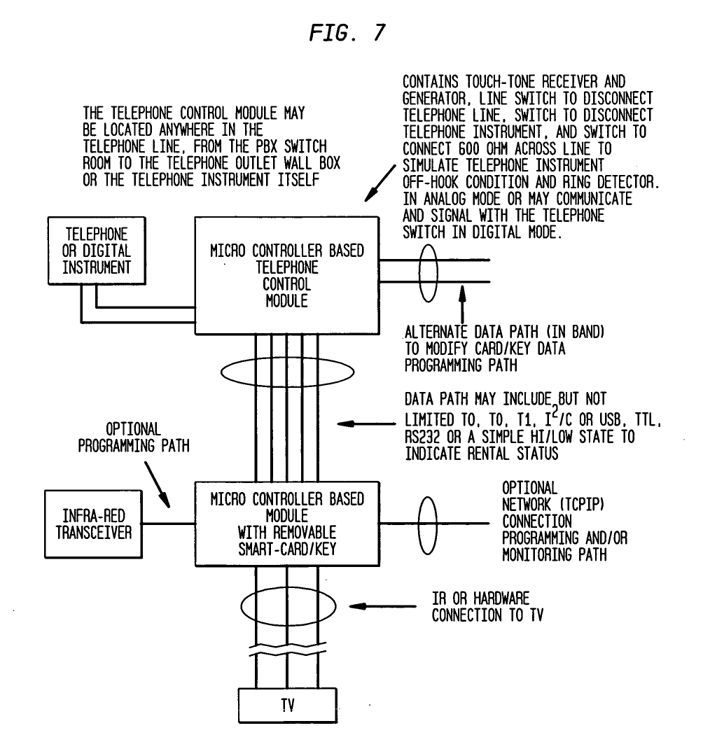

In an alternate arrangement shown in FIGS. 6 and 7, the control system can also be provided with a telephone control module 100 inserted into the telephone line 103 connecting or disconnecting the telephone instrument 106 from the line 103.

In the “lookup” table method, the SCCM monitors the digits dialed and then use “lookup tables” to determine what area codes and/or exchanges are allowed, either from the “free” or the “pay” tables. The lookup table data is retrieved by the SCCM 22 from the SCK 14 or is preloaded into the SCCM 22. If a call is not allowed a dial tone is presented to the user. Another alternative is for the telephone rental module to disconnect the local phone, and then dial into an extension that is routed to an announcement informing the user that the service must be paid for before the call is allowed.

A control signal is sent to the telephone control module 100 from the smart card module 109 to indicate whether the telephone instrument 106 should be in the “connected” or “disconnected” state. Furthermore, the module 100 may use intelligence to allow a “connected” state to complete calls to specific phone numbers or phone number prefixes. When a series of digits is dialed that is not in the look-up table, the module 100 immediately goes into the disconnected state, preventing the call from being completed. The look-up table of numbers or prefixes may be sent to the module by a hardwire, infrared, ultrasonic or radio frequency (RF) control signal from the smart card module 109. The same module 109 may also be used to control a television 112 as described above.

Furthermore the module is capable of capturing the first ring of an incoming call. If only one ring is received, the PHRM will answer the next call within a certain time limit and if the proper touch tone sequence follows that ring, receive programming instructions using in-band signaling (i.e., touch tones).

Furthermore the module can capture dialed numbers. As the digits are dialed, the module keeps the telephone instrument isolated from the telephone line. Depending on what level of rental service has been has been selected (i.e., local calls only, regional calls or long distance) the module can generate prefixes and suffixes to the dialed number which may be used in call routing. For instance, the prefix may contain digits that route the requested number to a specific outgoing trunk on the hospital or hotel telephone switch (PBX). The prefix may also be composed digits and pauses for calling card numbers or other desired codes. The prefixes and suffixes can be programmed into the module by the telephone instrument. Information is stored in the smart card/key or other programming data paths as discussed above.

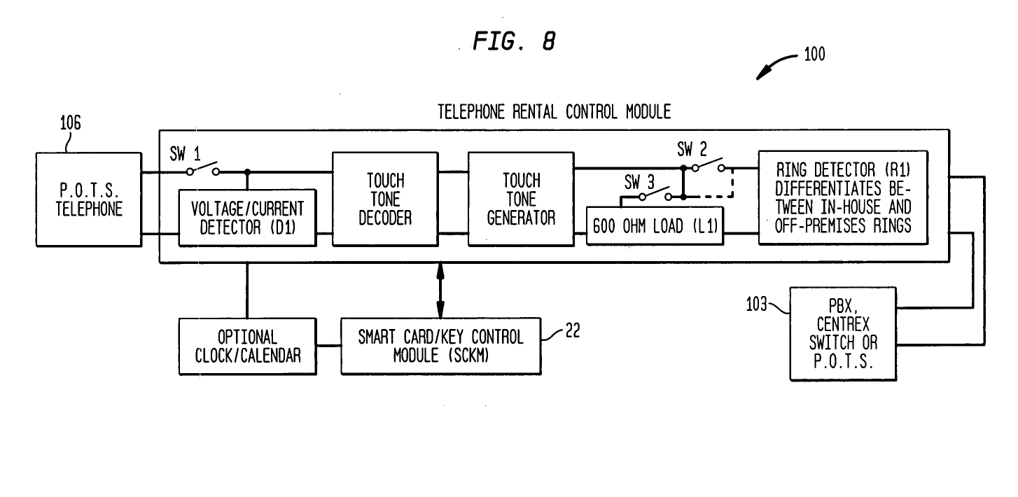

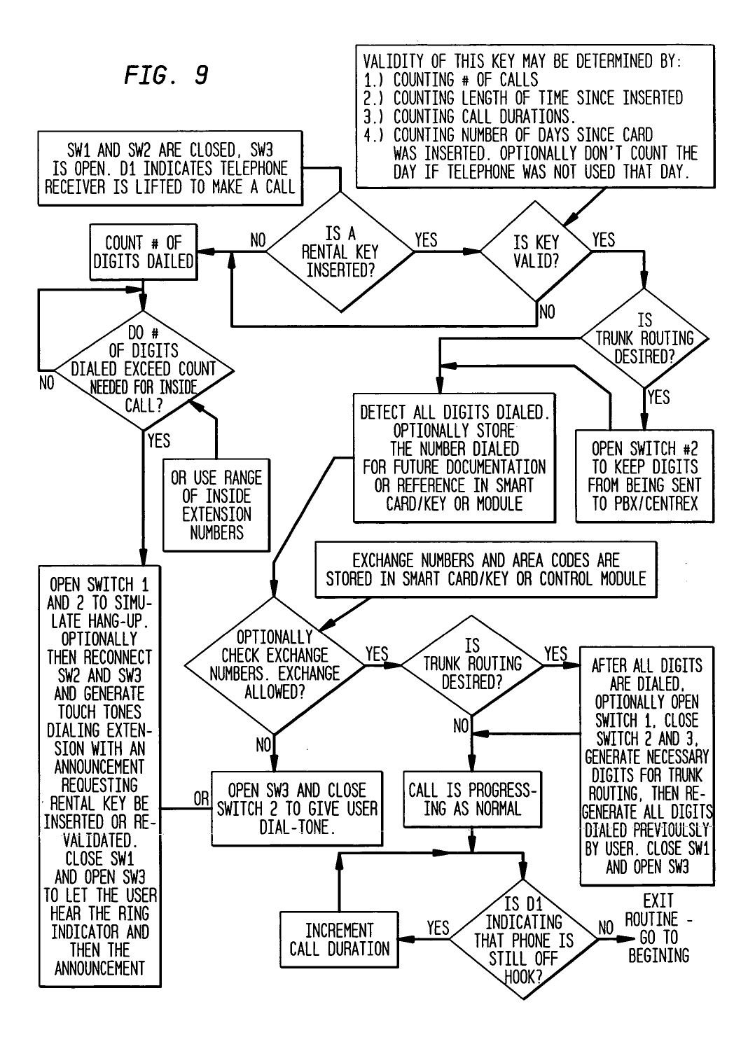

Referring to FIGS. 8 and 9, the rental module 100 may be connected in series between the telephone instrument 106 and the telephone switch 103. At the onset of operation switch 1 and switch 2 are closed and switch 3 is open. Voltage/current detector (D1) indicates when the telephone receiver is lifted to make a call. Next, the system checks to determine if a SCK 14 is inserted. If there is no SCK 14, the system counts the number of digits dialed to determine if they exceed the count needed for an inside call. If the count is exceeded, switch 1 and 2 are opened to simulate hang-up. As an option, switch 2 and switch 3 are reconnected and generate touch tones dialing an extension with an announcement requesting that the SCK 14 be inserted or re-validated. Switch 1 is closed and switch 3 is opened to let the user hear the ring indicator and the announcement. If a SCK 14 is detected, the system determines if the key is valid. The validity of the key may be determined based on several factors including: counting the number of calls, counting the length of time since the card was inserted, counting call durations, counting number of days since card was inserted. As an option, the system can be set to not count a day if the telephone was not used that day. If the key is not valid, then the routine set forth above where no key is detected is followed. If the key is valid, then the system proceeds in a certain manner depending on whether it has been set up for trunk routing. If trunk routing has been set up, the system opens switch 2 to keep the digits from being sent directly to the telephone switch 103. The system detects all of the digits that have been dialed and as an option, stores the number that was dialed for future documentation or reference in the smart card/key module 22. Next, the system may check the exchange numbers to see if exchange is allowed.

The telephone rental module 100 and smart card/key control module 22 (SCCM) may be used to restrict or allow regional and long distance calling as well as local calling. If used to dispense long distance and regional area calling, the pertinent area codes and exchanges are simply added to the “regional/long distance” list. Due to the number of area codes involved it is more practical to enter certain area codes such as 900 into the disallowed list. Accordingly, the user can be billed at an additional rate for regional and long distance calling.

If the exchange is not allowed, the system opens switch 3 and closes switch 2 to give the user a dial tone. If the exchange is allowed and after all digits are dialed, the system opens switch 1, closes switches 2 and 3, generates the necessary digits for trunk routing and then regenerates the digits necessary to complete the call that were previously dialed by the user. Next, the system closes switch 1 and opens switch 3. The call progresses and optionally the time of the call is incremented and stored. The system detects whether the voltage/current detector (D1) is indicating that the phone 106 is still off of the hook. If so, the call duration is incremented again.

If the system is not set up for trunk routing, then the system detects the digits that were dialed. Optionally, the system stores the number dialed for future documentation and then checks the exchange. The exchange numbers may be stored in the smart card/key 14 or control module 22. If the exchange is allowed the digits are sent to the telephone switch.

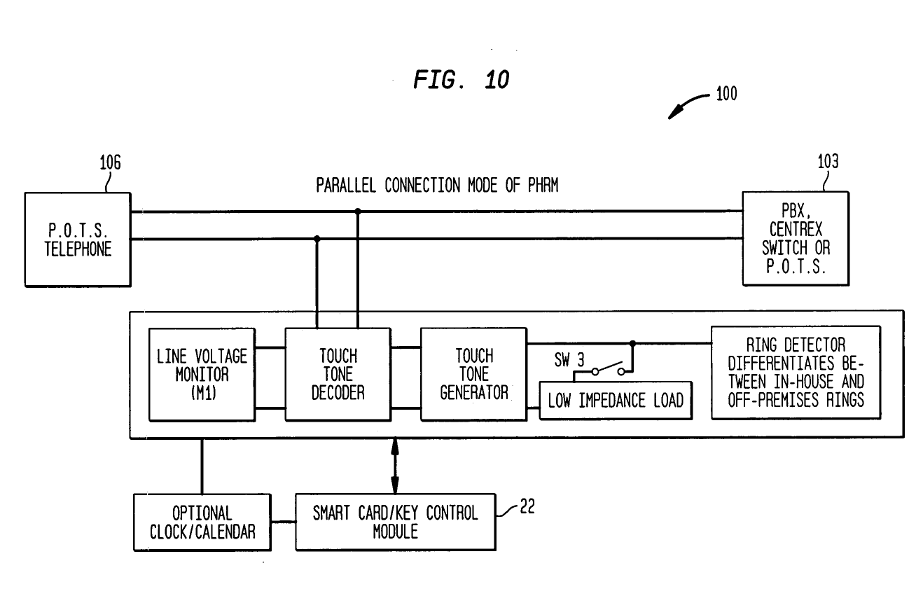

In FIG. 10, the parallel connection mode is shown. In the parallel connection mode it is still possible to have control over outgoing calls by generating digits (A, B, C, or D instead of 0-9) to interfere with the outgoing dialing. Thus, if the number of digits dialed exceeds the number need for in-house dialing, the touch tone generator dials illegal digits (A, B, C, or D) until the telephone instrument is hung up as indicated by the Line voltage monitor (M1). As an alternative method of interrupting the call, switch 3 can be thrown and a short put across the line. Then after a period of time, switch 3 is opened and M1 is examined to determine whether the telephone has been hung up. The procedure can be repeated if necessary.

Incoming calls are restricted in the following manner. For the serial connection mode, in “pay” mode switch 1 is closed and switch 2 is closed. The telephone instrument works as normal and receives all rings. In the “free” mode, switch 1 is normally closed and switch 2 is normally closed. When ring detector R1 detects the ringer voltage, switch 1 is immediately opened to prevent the ring from reaching the phone. While switch 1 is open, the call cannot be answered by the user. The telephone rental module captures the first ring and tests for inside or outside ring type. Typically two short rings or one long ring are the two types of rings. Telephone systems vary with regard to which one identifies the inside ring and which one identifies the outside ring. The type of ring detected is software configurable in the SCCM module.

In the parallel connection, in the “pay” mode no action is taken on incoming calls. In the “free” connection mode, ring detector R1 will signal a ring is occurring. Switch 3 is thrown to emulate a call pickup. Switch 3 is then opened to emulate a hang-up condition before the user has a chance to pick up the phone. If M1 indicates an off-hook condition still exists, M1 is closed again to cause a “low volume” condition by means of the low impedance load.

As another option for controlling telephone rental, when the “pay” service is initiated by insertion of a valid SCK, the PBX or Centrex switch is manipulated to change the COS (class of service) or similar control to allow the specified extension (user extension number) additional dialing privileges, along with removing any restrictions on incoming calls. When the SCK is removed or expires, the instruction to change the COS again is sent to the PBX or Centrex switch, this time restricting dialing and incoming calls. Incoming call restriction, outgoing call restriction, or both is an option.

Call control is typically handled by in-band signaling to the PBX or Centrex switch through an ISDN connection. With proper configuration of a PBX, an extension, as well as the switchboard, can change the class of service by sending, in-band (touch-tones), the extension number plus a “code” number specifying a class of service change plus the new type of class desired. The order of the information will depend on the specifications of the equipment manufacturers. The telephone rental module 100 can send the necessary codes to achieve incoming and outgoing call restrictions. Most PBX's however will only allow class of service change from an extension configured for “operator privilege.” If so, the telephone rental module will dial into a designated “operator privileged” extension and send it the in-band code. The extension will have a modified form of the telephone rental module whose software is programmed to accept the in-band touch tone stream. The call is then terminated. Then the modified telephone rental module will dial into the PBX and send the in-band signals. Since the calling extension has operator privilege, the class of service change is accepted by the PBX.

NEC PBXs usually do not accept in-band signaling. They do, however, provide for call control by means of an OAI interface that requires an IP network connection. The telephone rental module has IP connectivity as an option to communicate with the PBX OAI interface. However, since IP connectivity may require running network cables throughout the building (or complex of buildings) it is more advantageous in that case to use the in-band signaling method to a designated extension as described above to call into an extension whose instrument is a modem or voice response system or modified telephone rental module. Any means of answering the call and detecting the in-band signal may be used. Once decoded the command is sent to the PBX by means of the telephone rental module or a PC computer containing hardware and software to communicate through the OAI interface provided by NEC.

In another telephone rental system the system is composed of a voice response system and a patient or guest database. The database is constantly updated with patient/guest location by an interface to the hospital/hotel computer system. This database provides for accurate billing information and thus is constantly updated as changes such as admissions, transfers and discharges/checkouts occur. This information is especially important in a hospital environment as patients are transferred as treatment requires. It is quite common for patients to be on two or three different beds during a hospital stay. Some of the beds may not have rental telephones available.

In hotels the guest tracking is not as important because guests very seldom are transferred from room to room after check-in.

The patient or guest may opt for the service the first time that he or she makes an attempt to dial the extended area codes or long distance. Dialing instructions in the room direct the patient/guest to dial a specific number to get to an outside line. That number may be “8” or “*8” or any digit or series of digits that can be accommodated by the hospital/Hotel PBX so the call can be re-directed to a specific number (usually an extension inside the hospital/hotel) at which a voice response system picks up on the call. At this point the call may be handled by one of the following methods. If the patient/guest has not yet opted for the service, the voice response system will provide instructions to the patient/guest and provide the billing rates for the rental system (based on either the number of calls, length of calls or flat daily rate).

The patient/guest is instructed to push a digit such as “1” to acknowledge their desire to activate the service. If that digit is received the billing process is started and a billing record is created for the patient/guest. If the system includes the capability of credit card billing, the patient/guest is prompted to supply a major credit card. The card number is validated in real time and a dial tone is then presented to the caller. At this point the patient/guest can enter the desired number.

If the service has been activated, the user will immediately be presented with a dial tone. All digits dialed are captured. The system at this time will initiate an unsupervised transfer of the call dialing any necessary prefixes (i.e. routing digits) and the desired number and then goes on-hook, connecting the caller to the trunk on which the call is progressing. The system has the ability to insert a predetermined dialing prefix that will direct the call to a specific trunk chosen to carry patient/guest calls. This option is particularly useful if the PBX has a limited number of class of service (COS) definitions available. The routing may also be programmed according to time of day and/or weekends. A look-up table is available to associate local calls and specific area codes with predetermined trunks/trunk groups available to the PBX.

The present invention offers several advantages including the fact that this rental system provides a revenue collection process, which is completely automated if the Kiosk (vending) system is used to vend the SCK 14, as well as refunds for unused “pay” services. Simply inserting the SCK into the kiosk and choosing “refund” will return unused funds to the patient in cash, or in the form of credit to a major credit card if a credit card was used to purchase the SCK. The system requires no human intervention with secure funds management.

The system of the present invention could also be used for other applications such as parental control of a home television set. The SCK can be programmed by a parent on a PC and the television control module and SCCM can be attached to the television or cable box such that the IR remote signal is captured by the television control module and relayed to the television or cable box for allowable channels only.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

What is claimed:

1. An automated television rental system comprising:
a) a pillow/speaker control unit for a television;
b) a smart card control module connected to the pillow/speaker control unit, the smart card control module having a smart card reader;
c) a smart card received in the smart card reader:
d) a control wire connected to the pillow/speaker control unit and television allowing electronic communication between the smart card control module and television;
d) a pulse train generated by the smart card control module, the pulse train sent along the control wire to the television set, the pulse train for instructing the television to open or close free or commercial channel groups.

2. The automated rental system according to claim 1 wherein the smart card further comprises means for maintaining a balance of funds on the smart card.

3. The automated rental system according to claim 2 further comprising a clock, the clock in electronic communication with the means for maintaining a balance and the commercial channels, so that funds are automatically deducted by the means for maintaining a balance during the time the pulse train delivers commercial group signals to the television.

4. The automated rental system according to claim 3 wherein if the balance of funds on the smart card goes to zero, the smart card control module stops sending pulse train signals to the television for the commercial channel groups.

5. The automated rental system according to claim 2 wherein funds may be added to the smart card upon payment of a fee.

6. An automated rental system comprising:
a) a battery operated remote control pillow/speaker control unit for a television set;
b) a smart card control module comprising circuitry connected with the pillow/speaker control unit;
c) a pulse train generated by the smart card control module, the pulse train signal sent to the television set, the pulse train signal for instructing the television to open or close free or commercial channel groups.

7. The automated rental system according to claim 6 wherein the smart card further comprises means for maintaining a balance of funds on the smart card.

8. The automated rental system according to claim 7 further comprising a clock, the clock in electronic communication with the means for maintaining a balance and is in electronic communication with the smart card control module that is in electronic communication with the commercial channels, so that funds are automatically deducted by the means for maintaining a balance during the time the pulse train delivers commercial group signals to the television.

9. The automated rental system according to claim 8 wherein if the balance of funds on the smart card goes to zero, the smart card control module stops sending pulse train signals to the television for the commercial channel groups.

10. The automated rental system according to claim 7 wherein funds may be added to the smart card upon payment of a fee.

11. An automated rental system comprising:
a) a stand alone battery operated remote control pillow/speaker control unit for a television set;
b) a smart card control module comprising circuitry connected with the pillow/speaker control unit and having a smart card reader;
c) a pulse train generated by the smart card control module, the pulse train signal sent to the television set, the pulse train signal for instructing the television to open or close free or commercial channel groups.

12. An automated rental system comprising:
a) a stand alone battery operated remote control pillow/speaker control unit for a television set;
b) a smart card control module comprising circuitry connected with the pillow/speaker control unit;
c) a pulse train generated by the smart card control module, the pulse train signal sent to the television set, the pulse train signal for instructing the television to open or close free or commercial channel groups.

13. An automated rental system comprising:
a) a television comprising a receiver and a smart card control module having a smart card reader;
b) a smart card for carrying a balance, the smart card comprising an integrated circuit with RAM;
c) the smart card insertable into the smart card reader;
d) the smart card control module generating a pulse train signal sent to the television receiver to control the television, the pulse train signal for instructing the television to open or close free or commercial channel groups
e) the smart card control module further comprising a microprocessor in communication with the smart card so that when the commercial channels are accessed a fee is deducted from the balance of funds on the smart card.

14. The automated rental system according to claim 13 wherein the microprocessor further comprises a clock, the clock for determining the length of time the commercial channels have been accessed to determine the amount to be deducted from the balance.

15. A method for automated television rental comprising the acts of:
a) loading a smart card with a predetermined balance and selling the smart card;
b) providing a microprocessor on the smart card and a means for maintaining a balance on the smart card;
c) providing a pillow/speaker control unit for a television set;
d) providing a smart card control module connected with the pillow/speaker control unit, the smart card control module having a smart card reader;
e) inserting the smart card into the card reader;
f) generating a pulse train with the smart card control module, and sending the pulse train along the control wire to the television set, the pulse train for instructing the television to access free or commercial channel groups;
g) automatically deducting from the balance of the smart card when commercial channel groups are accessed.

16. The method for automated television rental according to claim 15 further comprising the acts of:
a) providing the microprocessor with the capability to keep track of time so fees may be deducted from the balance for the time the commercial channel groups are accessed.

17. The method for automated television rental according to claim 15 further comprising the acts of:
a) sending a signal to the television for selecting a channel group on the basis of the funds available on the smart card.

18. The method for automated television rental according to claim 15 comprising the further acts of and selling the smart cards for a fee.

19. An automated television rental system, comprising:
a television rental control module having a command decoder and a command generator;
a smart card control module having a smart card reader, the smart card control module in electronic communication with the television rental control module;
a smart card received in the smart card reader;
wherein the smart card control module receives input from the command decoder and the smart card and generates an output for controlling the television via the command generator.

20. The system of claim 19, wherein the smart card control module retrieves data regarding available channels from a lookup table.

21. The system of claim 20, wherein the lookup table is retrieved from the smart card.

22. The system of claim 19, wherein the smart card further comprises means for maintaining a balance of funds on the smart card.

23. The system of claim 19, wherein the smart card control module is provided with an identifying address that can be used to determine which channels are available for viewing.

24. The system of claim 19, wherein the command generator generates a command corresponding to an individual channel.

25. The system of claim 19, wherein the command generator generates a command corresponding to a tier of channels.

26. The system of claim 19, wherein the command generator generates a signal to be carried by a control wire from a pillow/speaker unit.

27. The system of claim 19, wherein the command generator generates a pulse train for instructing the television to open or close free or commercial channel groups.

28. A telephone rental system, comprising:
a telephone rental control module having a touch tone decoder and a touch tone generator;
a smart card control module with a smart card reader, the smart card control module in electronic communication with the telephone rental control module;
a smart card received in the smart card reader;
wherein the smart card control module receives input from the touch tone decoder and the smart card and generates output to a telephone switch via the touch tone generator.

29. The system of claim 28, wherein the smart card control module retrieves data regarding available area codes and exchanges from a look up table.

30. The system of claim 29, wherein the lookup table is retrieved from the smart card.

31. The system of claim 28, wherein the smart card further comprises means for maintaining a balance of funds on the smart card.

32. The system of claim 28, wherein the smart card control module stores data from the touch tone decoder regarding the digits dialed by the user.

33. The system of claim 32, wherein the smart card control module regenerates the dialed digits and sends them to the telephone switch via the touch tone generator.

34. A method for automated television and telephone rental, comprising:
a) loading a smart card with a predetermined balance and vending the smart card;
b) providing a television rental control module (TVRM) having a command decoder and a command generator;
c) providing a telephone rental control module (PHRM) having a touch tone decoder and a touch tone generator;,
d) providing a smart card control module (SCCM) in electronic communication with the TVRM and the PHRM;
e) inserting the smart card into the smart card reader;
f) receiving input into the smart card control module from the command decoder and the smart card and generating output for controlling the television via the command generator, wherein the input from the smart card includes data regarding rental value;
g) receiving input into the smart card control module from the touch tone decoder and the smart card and generating output for sending to a telephone switch via the touch tone generator, wherein the input from the smart card includes data regarding rental value.

35. The method of claim 34, further comprising,
retrieving data regarding available channels from a look up table containing information regarding “free” and “pay” channels.

36. The method of claim 35, further comprising,
retrieving look up tables containing information regarding “free” and “pay” channels from the smart card into the smart card control module.

37. The method of claim 35, further comprising,
retrieving look up tables containing information regarding available area codes and exchanges from the smart card into the smart card control module.

38. The method of claim 35, further comprising,
providing a kiosk for vending smart cards.

39. The method of claim 38, further comprising, refunding unused funds remaining on smart cards via the kiosk.

40. A method for parental control of a television, comprising;
loading a smart card with a list of available channels by means of a PC;
providing a television control module having a command decoder and a command generator;
providing a smart card control module having a smart card reader, the smart card control module in electronic communication with the television control module;
inserting the smart card into the smart card reader;
receiving decoded input from the command decoder and input from the smart card in the form of a lookup table containing available channels and generating output for controlling the television via the command generator.
